(19) United States
(12) Patent Application Publication
(10) Pub. No.: US 2007/0028853 A1
(43) Pub. Date: Feb. 8, 2007

(54) Pet confinement system using ultra wideband

(75) Inventor: Randal D. Boyd, Knoxville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/196,903

(22) Filed: Aug. 4, 2005

(51) Int. Cl. A01K 15/04

(52) U.S. Cl. 119/721

(57) ABSTRACT

Described is a pet confinement system for confining the monitored pet using negative reinforcement and ultra wideband technology. A transmitter generates a ultra wideband signal monitored by a receiver carried by the pet. The negative reinforcement delivery circuit provides a corrective stimulus of adjustable intensity. The owner selects the intensity level using a conventional switch device.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a device for pet confinement. More particularly, this invention pertains to a device for confining pets using an adjustable corrective stimulus administered by a collar mounted device that is adapted for ultra wideband communication.

2. Description of the Related Art

In the field of pet training it is well known that negative reinforcement can be used to deter animals from taking certain actions. More specifically, a radio-controlled, low-current electrical stimulus can be used to confine an animal within a defined area. Typically, a short-range transmitter produces a signal received by a battery-powered collar worn by a pet. When the receiver is moved into the range of the transmitter, a low-current electrical stimulus is administered to the pet through a pair of terminals.

Conventional electronic devices for monitoring a person or animal or confining an animal have been previously disclosed. Typical of the art are radio frequency (RF) person monitoring devices. Each device broadcasts an RF signal from a transmitter for reception by a receiver and generates an alert when the RF signal strength at the receiver drops below a specified threshold.

Additionally, another typical device provides for at least two transmitter/receiver devices. The first is a stationary unit which broadcasts a short range RF signal to at least one mobile unit. A variable threshold discriminator allows a predetermined range to be set for each mobile unit. When outside the predetermined range, the mobile unit transmits an identification-encoded RF signal to the base unit generating an alert condition. Additionally, if desired, the mobile unit can sound a warning to the wearer.

Similarly, another typical device provides for a beacon unit and a tracking unit. The beacon unit is worn or carried by the person to be monitored and broadcasts an RF signal to the tracking unit. When the RF signal drops below an adjustable threshold level, an alert is generated at the tracking device and visually indicates the direction of the beacon unit relative to the tracking unit.

Finally, another typical device provides for a mobile unit which broadcasts an RF signal and is worn or carried by the person to be monitored. The base unit has an adjustable threshold level for monitoring the RF signal. As the signal strength received at the base unit decreases, indicating that the mobile unit is approaching the threshold range, a graduating alert is generated at the base unit until a full alert is generated when the mobile unit exceeds the threshold range.

Other types of conventional devices monitor an area for intrusion and generate an alarm. This type of device generates an electromagnetic field (EMF). Disturbing the EMF generates a verbal warning. Disturbances which continue for a specified time period generate a verbal alarm.

Also typical in the art are electronic pet confinement devices. Each of the aforementioned devices incorporate a collar responsive to an RF signal which generates a corrective stimulus should the pet attempt to leave the confinement area. Furthermore, each device includes features designed to overcome perceived deficiencies in the prior art.

Another conventional device utilizes a transmitter and a pair of wire-loop broadcast antennas to define the confinement zone. A collar worn by the pet reacts to RF signals broadcast from the wires. The signal from the first wire causes the collar to generate a corrective stimulus. The signal from the second wire causes an alert to sound at a base unit, deactivates the signal from the first wire until manually reset to avoid generating a corrective stimulus should the animal return to the confinement area, and activates a speaker located in the collar to broadcast verbal commands from the owner using a microphone and transmitter. Using RF signals of differing frequencies allows the base unit to identify which of multiple animals tripped the alarm.

Another conventional device includes a transmitter, a wire-loop broadcast antenna, and a collar for generating a corrective stimulus. Two orthogonal receiving antennas and signal monitoring circuitry are incorporated into the collar for enhancing reception of the RF signal regardless of the orientation of the collar as it approaches the loop antenna.

Another conventional device includes a conventional electronic pet confinement system. As the pet approaches the loop antenna, a first signal strength threshold generates a previously recorded verbal warning command from the owner. A second signal strength threshold reinforces the verbal warning with an electrical shock. To enhance reliability, the device monitors the broadcast antenna for a break in continuity and the transmitter power supply for loss of AC power and generates an alert should either condition occur.

Another conventional device utilizes a conventional electronic confinement system incorporating a modulated RF signal for verification and a disruption generator to eliminate re-broadcasting of the RF signal through structures such as metallic pipes or cables. The disruption generator is attached to structures likely to rebroadcast the RF signal and generates a second RF signal which disrupts the modulation identification signal through phase shifting or alternative modulation, thereby preventing the collar from applying a corrective stimulus.

Another conventional device also incorporates a modulated RF signal which is demodulated and compared to a reference signal to verify its authenticity. Various frequencies can be utilized to uniquely identify more than one pet. As with an aforementioned device, a pair of wire-loop broadcast antennas are utilized, each broadcasting an independent RF signal. The first wire serves to define a confinement area. As a pet approaches the first wire, a corrective stimulus is applied. Should the pet continue, the increase in the RF signal strength generates an alert condition at a base unit, deactivates the corrective stimulus circuitry, and activates a speaker in the collar to allow issuance of verbal commands using a microphone. When the pet returns to the confinement area and approaches the second wire, located proximate to the base unit, the corrective stimulus circuitry is automatically reactivated to confine the pet. This device includes power saving circuitry to reduce power consumption and generate a low battery alert for each collar. Finally, this device provides a potentiometer for adjusting the sensitivity of the RF signal strength threshold allowing the range at which the corrective stimulus is applied to be varied and a potentiometer for adjusting the level of the corrective stimulus to account for pets having differing sensitivities.

Another type of conventional device expands upon the prior art. This type of device incorporates three orthogonal antennas and uses a modulation of the RF signal to reduce the likelihood that stray RF signals will generate erroneous correction stimuli. As is typical in the art, this type of device generates a warning followed by a corrective stimulus, after an adjustable delay, should the animal remain in the warning zone. Additionally, this type of device provides compliant conductive tips to reduce irritation to the pet. Power saving circuitry prolongs battery life and provides a warning when the battery charge is weak. Furthermore, an isolation transformer protects the transmitter from lightning and power surges. Finally, this type of device includes circuitry preventing excessive use of the corrective stimulus, for example, should the pet become trapped near the boundary of the confinement area. In such instance, the corrective stimulus is deactivated until the collar has been outside the range of the boundary signal for a specified period of time.

### BRIEF SUMMARY OF THE INVENTION

In accordance with the various features of the present invention there is provided a pet confinement system for confining an animal using an ultra wideband-controlled negative reinforcement collar.

The pet confinement system is designed for confining animals using negative reinforcement by administering an adjustable, non-lethal corrective stimulus when the monitored pet moves outside a specified confinement area.

The pet confinement system comprises a transmitter device and a collar device. The transmitter device is an ultra wideband transmitter emitting an ultra wideband signal over a wide spectrum of frequency bands at a very low power level.

The collar device is adapted for ultra wideband communication and allows for the monitoring of the location of the collar device relative to the transmitter device and applies a corrective stimulus upon detection of a signal broadcast from the transmitter.

A negative reinforcement delivery device incorporates a conventional switching device allowing a user to select the corrective stimulus, which can be an electrostatic shock or an ultrasonic pulse.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates the pet confinement system of the present invention showing the collar device being worn by an animal.

FIG. 2 is a block diagram illustrating various features of the pet confinement system of FIG. 1.

### DETAILED DESCRIPTION OF THE INVENTION

A pet confinement system for confining animals incorporating various features of the present invention is illustrated generally at 10 in the figures. The pet confinement system 10 is designed for confining pets using negative reinforcement and ultra wideband technology. Moreover, the pet confinement system 10 is designed for administering at least one type of corrective stimuli, including a non-lethal corrective stimulus, when the monitored pet 12 moves outside of at least one defined confinement area.

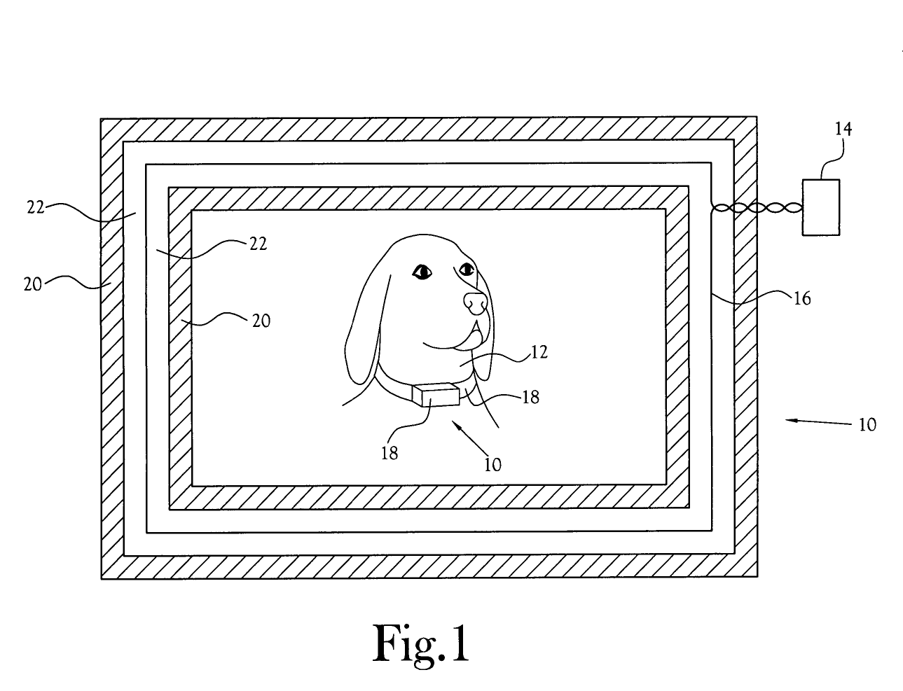

FIG. 1 illustrates various components of the pet confinement system 10 in operation. The pet confinement system 10 comprises a transmitter 14, at least one transmitting antenna 16, and a collar 18. The transmitter 14 comprises an ultra wideband transmitter which transmits an ultra wideband signal over a wide spectrum of frequency bands. The transmitting antenna 16 defines the boundaries of the confinement area. The ultra wideband signal is monitored by the collar 18 which responds by administering at least one type of negative reinforcement to the monitored pet 12 based on the ultra wideband signal. As the monitored pet 12 approaches a warning zone 20 proximate to the transmitting antenna 16, the collar 18 detects the ultra wideband signal and generates a warning stimulus. Should the monitored pet 12 move closer to the transmitting antenna 16 into correction area 22, the increase in signal strength causes the collar 18 to generate a corrective stimulus accompanied by the warning stimulus. One skilled in the art will recognize that various mechanisms for achieving multiple levels of correction may be used, such as signal threshold monitoring or multiple transmitting antennas carrying differing signals.

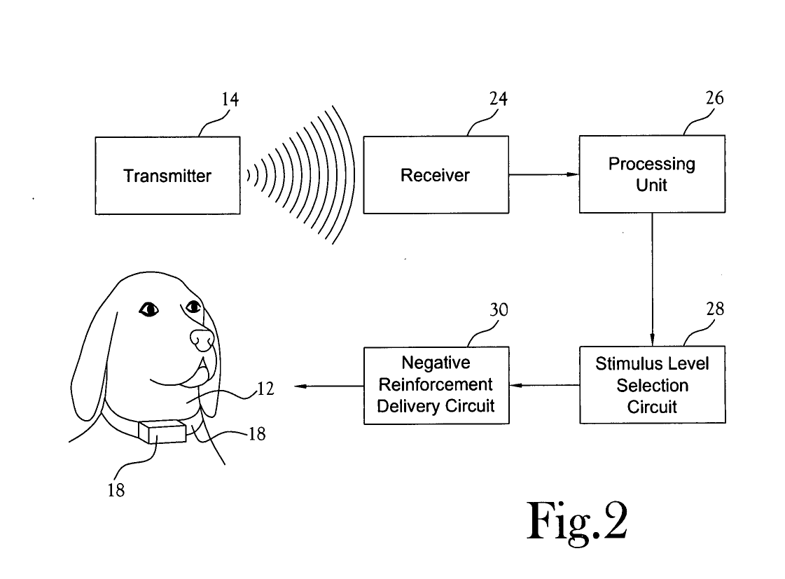

FIG. 2 illustrates a block diagram of the pet confinement system 10. A transmitter 14 broadcasts an ultra wideband signal for defining a confinement boundary. A receiver 24, disposed within collar 18, receives the signal and passes the signal to processing unit 26. Processing unit 26 analyzes the received signal and, together with the stimulus level selection circuit 28, activates the negative reinforcement delivery circuit 30. The negative reinforcement delivery circuit 30 applies the corrective stimulus to the pet 12. One skilled in the art will recognize that the negative reinforcement delivery circuit 30 can deliver various types of corrective stimuli, such as electrostatic corrections, audible corrections and sprayed irritants, such as citronella.

The collar 18 monitors the ultra wideband signal from the transmitting antenna 16 and responds when appropriate. As ultra wideband signals are received by receiver 24, a processing unit 26 processes the input and generates the appropriate response from the collar 18. To achieve its function, the collar 18 includes a negative reinforcement delivery circuit 30 and a stimulus level selection circuit 28. In the illustrated embodiment, the negative reinforcement delivery circuit 30 is configured to deliver an electrostatic shock. However, as previously discussed, one skilled in the art will recognize that the negative reinforcement delivery circuit 30 can deliver other stimuli as well.

A stimulus level selection circuit 28 allows a user to select the desired corrective stimulus which elicits the appropriate response from the pet 12 and reduces concern over excessive negative reinforcement. In the illustrated embodiment, the minimum intensity corrective stimulus consists only of an audible correction sound generated.

The negative reinforcement delivery circuit 30 generates a corrective stimulus of desired variety, transfers the corrective stimulus from the collar device 18 to the monitored pet 12, and provides an audible signal independent of other negative reinforcement. In the illustrated embodiment, the corrective stimulus is a non-lethal, high-voltage, electrical stimulus coupled with an audible correction sound. One skilled in the art will recognize that other types and combinations of corrective stimuli could be used, such as a substance or odor which is irritating to the pet. In the illustrated embodiment, for purposes of discussion, the negative reinforcement delivery circuit 30 is configured to deliver an electrical shock.

Operation of the pet confinement system 10 requires the pet owner to define a confinement area with the transmitting antenna 16 and activate the transmitter 14. The collar is fitted on the pet 12 to be monitored. A type of corrective stimulus is selected and the collar 18 is activated. When the pet 12 approaches the boundary of the confinement area, a warning stimulus is applied. Should the pet approach closer to the boundary, a corrective stimulus is applied. Should the intensity of the corrective stimulus be too harsh or too mild to be effective, the pet owner can select a new corrective stimulus.

From the foregoing description, it will be recognized by those skilled in the art that a pet confinement system offering advantages over the prior art has been provided. Specifically, the pet confinement system provides ultra wideband communication between the transmitter and the receiver. Further, the pet confinement system provides an adjustable correction stimulus to permit owners to customize the correction to the individual pet.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A pet confinement system for confining pets using an adjustable corrective stimulus administered by a collar mounted device that is adapted for ultra wideband communication, said pet confinement device comprising:
a transmitter, said transmitter adapted for ultra wideband communication;
a receiver, said receiver in ultra wideband communication with said transmitter, said receiver carried by a pet; and
a negative reinforcement delivery circuit for delivering a corrective stimulus to the monitored pet when the monitored pet is located outside the confinement zone, said negative reinforcement delivery circuit in electrical communication with said receiver.

2. The pet confinement system of claim 1, further comprising a stimulus level selection circuit for selecting a corrective stimulus, said stimulus level selection circuit in electrical communication with said receiver and said negative reinforcement delivery circuit.

3. The pet confinement system of claim 1 wherein the corrective stimulus is a non-lethal, variable voltage, electrical shock.

4. The pet confinement system of claim 1 wherein said negative reinforcement delivery circuit includes an ultrasonic transducer for generating the corrective stimulus to administer to the monitored pet.

5. The pet confinement system of claim 4 wherein the corrective stimulus is an ultrasonic pulse.

6. The pet confinement system of claim 1 wherein said negative reinforcement delivery circuit includes a vibration generator for generating the corrective stimulus to administer to the monitored pet.

7. The pet confinement system of claim 6 wherein the corrective stimulus is a vibration.

8. A pet confinement system for confining a monitored pet which includes a transmitter for defining a confinement zone and a collar configured for being worn by the monitored pet including a pet monitoring device for monitoring the signal of the transmitter and a negative reinforcement delivery device for delivering a corrective stimulus to the monitored pet as required, said pet confinement system comprising:
a collar for encircling the monitored pet;
a receiver disposed within said collar, said receiver adapted for ultra wideband communication;
a intensity level selection circuit for selecting a corrective stimulus, said intensity selection circuit disposed within said collar and electrically connected to said receiver, said intensity selection circuit providing a plurality of the corrective stimulus, the corrective stimulus being a non-lethal, electrical shock;
a negative reinforcement delivery circuit for delivering the corrective stimulus of said intensity level selection circuit to the monitored pet when the monitored pet is located outside the confinement zone, said negative reinforcement delivery circuit disposed within said collar and electrically connected to said intensity level selection circuit; and
a transmitter for transmitting an ultra wideband signal, said transmitter in communication with said receiver.
